(19) United States
(12) Patent Application Publication
(10) Pub. No.: US 2015/0138128 A1
(43) Pub. Date: May 21, 2015

(54) Expanded Function Touch Sensor Implement

(71) Applicant: Apple Inc., Cupertino, CA (US)

(72) Inventors: Christopher J. Herrick, San Francisco, CA (US); Agustya R. Mehta, Mountain View, CA (US)

(73) Assignee: Apple Inc., Cupertino, CA (US)

(21) Appl. No.: 14/084,990

(22) Filed: Nov. 20, 2013

(51) Int. Cl. G06F 3/041; G06F 3/045; G06F 3/0354; G06F 3/044

(52) U.S. Cl. CPC G06F 3/041; G06F 3/044; G06F 3/045; G06F 3/03545
USPC 345/174; 345/173

(57) ABSTRACT

A touch sensor device includes a number of receiving elements that are operable to receive signals from one or more of a number of transmitting elements when one or more areas of the touch sensor device are contacted with an implement. Such received signals are interpreted by the touch sensor device as touch input. The implement includes a signal source and one or more selection elements that control the amplitude with which a signal from the signal source is provided to the touch sensor device. Such signals from the implement are received by one or more of the receiving elements of the touch sensor device and interpreted as touch input and/or non-positional information regarding other received touch input.

### TECHNICAL FIELD

This disclosure relates generally to touch sensor devices, and more specifically to an implement for use with touch sensor devices that has expanded functionality.

### BACKGROUND

Touch sensor devices (such as touch screens, track pads, and/or any other device that interprets one or more touches as input) may detect the position of a touch as input. As part of such operation, touch sensor devices may include multiple touch sensitive areas. The position of the detected touch may depend on the touch sensitive area that is activated.

Some touch sensor devices may be utilizable with one or more implements, such as one or more styluses. For example, a stylus configured for use with a capacitive touch screen or track pad may include a tip that may affect the capacitance of one or more areas of the touch screen or track pad. Based on the detected capacitance of the various areas, the touch of the stylus may be detected and utilized as input.

However, input information from such a stylus or other implement may be limited to detecting the touch at the exact tip of the stylus or other implement. Unlike a finger, which may “mash” or otherwise be deformable to contact a variable area of a touch sensor, the physical area contactable by a stylus or other implement may not be controllable. As such, use of a stylus or other implement with a touch sensor may not be as flexible as use of a finger or other body part.

### SUMMARY

The present disclosure discloses systems and methods for expanded functionality of an implement utilized with a touch sensor device. A touch sensor device may include a number of receiving elements that are operable to receive signals from one or more of a number of transmitting elements when one or more areas of the touch sensor device are contacted with an implement. Such received signals may be interpreted by the touch sensor device as touch input. The implement may include a signal source and one or more selection elements that control the amplitude with which a signal from the signal source is provided to the touch sensor device. Such signals from the implement may be received by one or more of the receiving elements of the touch sensor device and interpreted as touch input and/or non-positional information regarding other received touch input. In this way, the functionality of the implement when utilized with the touch sensor device may be enhanced.

In some implementations, the signal provided by the implement may be received by receiving elements that are associated with portions of the touch sensor device not physically contacted by the implement and such may be interpreted as if the portions had been physically contacted by the implement. Such receiving elements may be adjacent and/or proximate to portions of the touch sensor device associated receiving elements that receive signals from transmitting elements as a result of physical contact with the implement. The number of the receiving elements that receive the signal from the implement may be dependent on the amplitude of the signal. As such, the amount of the touch sensor device activated by contact with the implement may be controllable via the selection element of the implement. In such implementations, the signal provided by the implement and the signals transmitted by the transmitting elements may be modulated with the same modulation.

In other implementations, the signal provided by the implement may be interpreted by the touch sensor device as information corresponding to a detected touch other than positional information. Such information may indicate any kind of information regarding the touch and may include, but is not limited to, color information to be utilized with the detected touch, vibrancy information to be utilized with the detected touch, hue information to be used with the detected touch, brush stroke and/or other art implement information to be used with the detected touch, tone information to be used with the detected touch, line type information to be used with the detected touch, selection information to be used with the detected touch, and/or any other such touch related information.

In some cases, the selection element may be a grip sensor that senses the amount of force with which a user grips the implement. In other cases, the selection element may be a pressure sensor that senses an amount of pressure exerted on the implement by a user. In still other cases, the selection element may be a strain gauge that detects a strain exerted by the user on the implement. In yet other cases, the selection element may be one or more buttons and/or any other element utilizable by a user to provide a range of inputs.

In various implementations, the signal provided by the implement to the touch sensor device may be omnidirectional. However, in other implementations, the direction of the signal provided by the implement may be controlled. For example, the implement may include one or more shielding elements that control which portions of the touch sensor device the signal is provided. Such shielding elements may be controllable, such as by software and/or by mechanical control.

In one or more implementations, a system for expanded touch sensor implement functionality may include: a touch sensor device including a plurality of receiving elements and an implement including: at least one signal source that provides at least one signal; and at least one selection element that controls an amplitude at which the at least one signal is provided to the touch sensor device. At least one of the plurality of receiving elements receives the at least one signal.

In various implementations, an implement utilizable with a touch sensor device includes at least one signal source that provides at least one signal and at least one selection element that controls an amplitude at which the at least one signal is provided to a touch sensor device that includes a plurality of receiving elements. At least one of the plurality of receiving elements receives the at least one signal.

In some implementations, a method for expanded touch sensor device implement functionality may include: receiving at least one first signal utilizing a receiving element of a plurality of receiving elements of a touch sensor device from a transmitting element of the touch sensor device based on a contact of an implement with a portion of the touch sensor associated with the receiving element; receiving at least one second signal utilizing at least one of the plurality of receiving elements from the implement wherein an amplitude of the at least one second signal is controlled by at least one selection element of the implement; and determining a touched area of the touch sensor including at least the portion. The second signal is interpreted as at least one of indicating an additional portion of the touch sensor that is not contacted by the implement to include in the touched area in addition to the portion or indicating information other than positional information about a touch of the touch area.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1A is an isometric view of a system for expanded functionality of an implement utilized with a touch sensor device.

FIG. 1B is a block diagram illustrating the functionality of a portion of the touch sensor device of FIG. 1A

FIG. 1C is a block diagram illustrating the functionality of an embodiment of an area of the portion of the touch sensor device illustrated in FIG. 1B.

FIG. 1D is a block diagram illustrating the functionality of an example implementation of the implement of FIG. 1A.

FIG. 2A is a first side view of an alternative embodiment of the implement of FIG. 1A.

FIG. 2B is a second side view of the alternative embodiment of the implement of FIG. 1A.

FIG. 3 is a flow chart illustrating a method for expanded touch sensor device implement functionality. This method may be performed by the system of FIG. 1A.

### DETAILED DESCRIPTION

The description that follows includes sample systems, methods, and computer program products that embody various elements of the present disclosure. However, it should be understood that the described disclosure may be practiced in a variety of forms in addition to those described herein.

The present disclosure discloses systems and methods for expanded functionality of an implement utilized with a touch sensor device. A touch sensor device (such as a touch screen track pad, a capacitive touch sensing device, or other such touch sensor device) may include a number of receiving elements that are operable to receive signals from one or more of a number of transmitting elements when one or more areas of the touch sensor device are contacted with an implement (such as a stylus). Such received signals may be interpreted by the touch sensor device as touch input. The implement may include a signal source and one or more selection elements that control the amplitude with which a signal from the signal source is provided to the touch sensor device. Such signals from the implement may be received by one or more of the receiving elements of the touch sensor device and interpreted as touch input and/or non-positional information regarding other received touch input. In this way, the functionality of the implement when utilized with the touch sensor device may be enhanced.

In some implementations, the signal provided by the implement may be received by receiving elements that are associated with portions of the touch sensor device not physically contacted by the implement and such may be interpreted as if the portions had been physically contacted by the implement. Such receiving elements may be adjacent and/or proximate to portions of the touch sensor device associated receiving elements that receive signals from transmitting elements as a result of physical contact with the implement. The number of the receiving elements that receive the signal from the implement may be dependent on the amplitude of the signal (such as where increasing the amplitude of the signal increases the number of receiving elements that receive the signal). As such, the amount of the touch sensor device activated by contact with the implement may be controllable via the selection element of the implement. In such implementations, the signal provided by the implement and the signals transmitted by the transmitting elements may be modulated with the same modulation.

In some cases, the selection element may be a grip sensor that senses the amount of force with which a user grips the implement. In other cases, the selection element may be a pressure sensor that senses an amount of pressure exerted on the implement by a user. In still other cases, the selection element may be a strain gauge that detects a strain exerted by the user on the implement. In yet other cases, the selection element may be one or more buttons and/or any other element utilizable by a user to provide a range of inputs.

For example, in some cases, the implement may include a signal source coupled to a transmitter element and the selection element by a variable resistor and an amplifier. As such, increased force or pressure exerted on the selection element by a user may cause the selection element via the variable resistor and the amplifier to direct an increasingly amplified signal from the signal generator to the transmitter element.

In other implementations, the signal provided by the implement may be interpreted by the touch sensor device as information corresponding to a detected touch other than positional information. For instance, a receiving element may receive a signal from a transmitting element as a result of contact with the implement and may also receive a signal from the implement that encodes information regarding the contact. The two signals may be modulated utilizing different modulations. Such information may indicate any kind of information regarding the touch and may include, but is not limited to, color information to be utilized with the detected touch, vibrancy information to be utilized with the detected touch, hue information to be used with the detected touch, brush stroke and/or other art implement information to be used with the detected touch, tone information to be used with the detected touch, line type information to be used with the detected touch, selection information to be used with the detected touch, and/or any other such touch related information.

In still other implementations, the implement may provide a first signal that is modulated with a same modulation as signals provided by transmitting elements of the touch sensor device and a second signal that is differently modulated. In such an implementation, the touch sensor device may utilize the first signal to determine the extent of the touch sensor device that is activated by contact with the implement and the second signal to obtain non-positional information to utilize with the detected touch.

In various implementations, the signal provided by the implement to the touch sensor device may be omnidirectional. However, in other implementations, the direction of the signal provided by the implement may be controlled. For example, the implement may include one or more shielding elements that control which portions of the touch sensor device the signal is provided. Such shielding elements may be controllable, such as by software and/or by mechanical control.

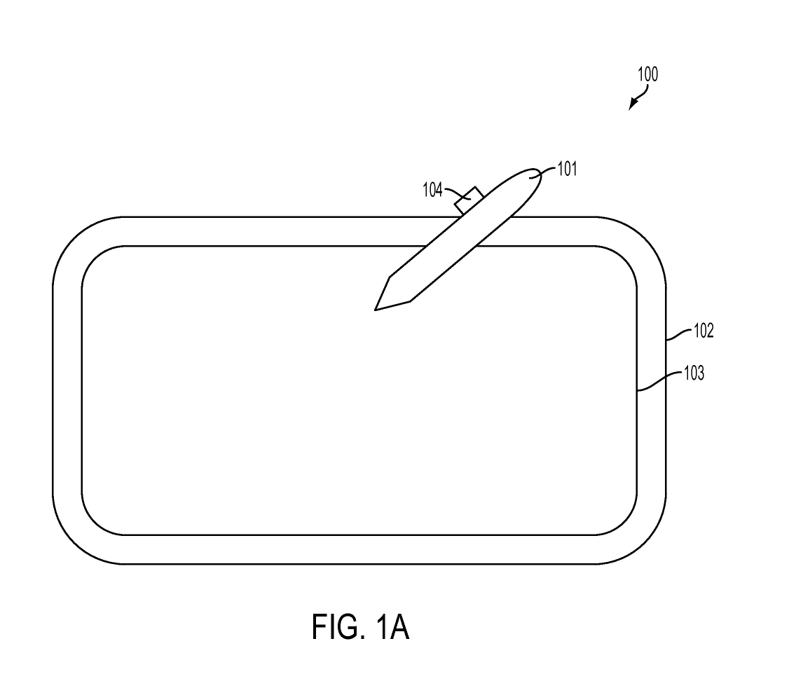

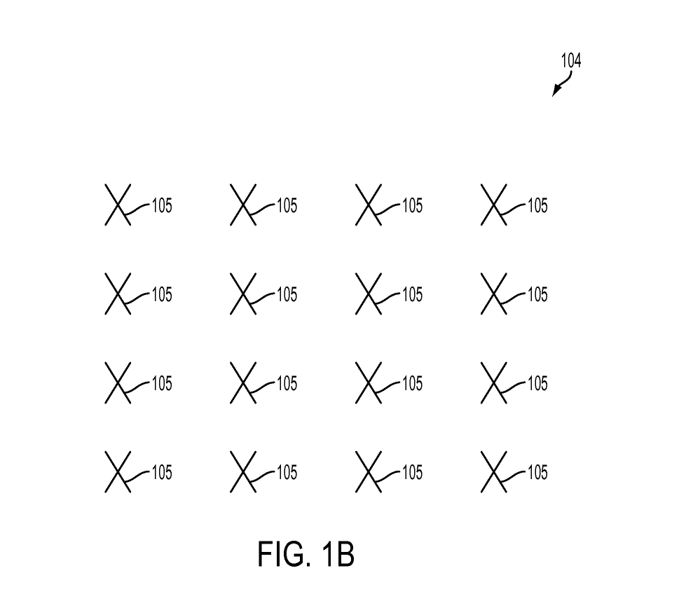

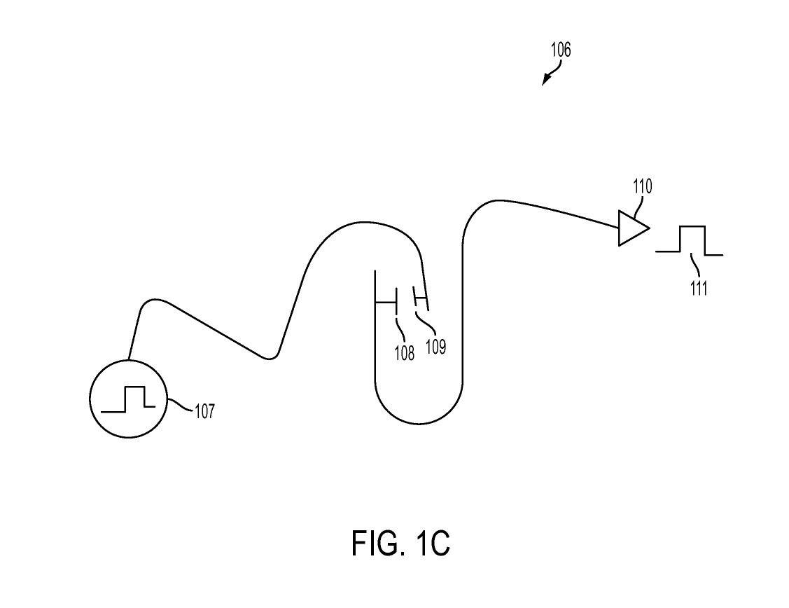

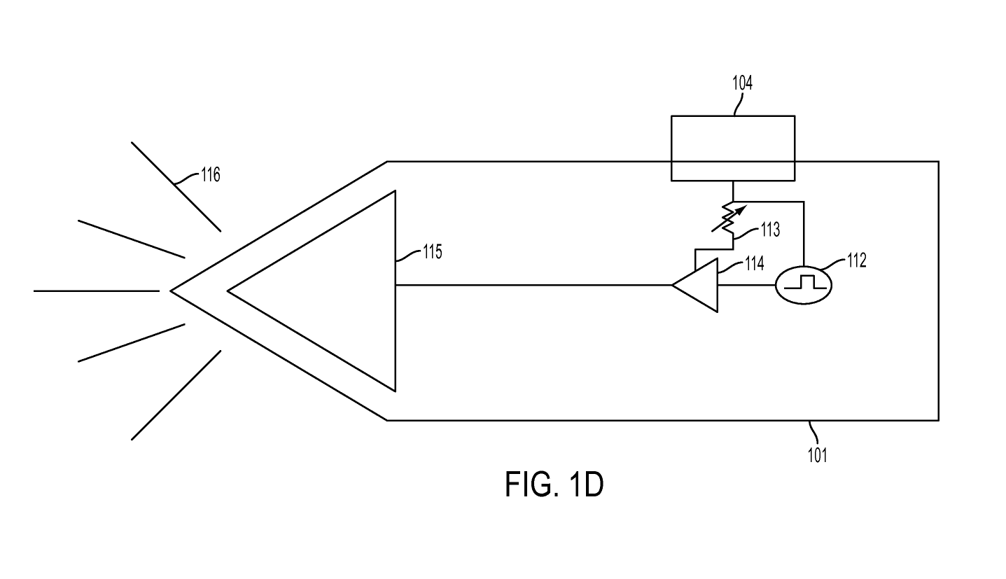

FIG. 1A is an isometric view of a system 100 for expanded functionality of an implement 101 utilized with a touch sensor device 102. As illustrated, the implement is a stylus and the touch sensor device is a touch screen 103 of a tablet computer. However, it is understood that this is an example. In various implementations, the implement may be any kind of implement and the touch sensor device may be any kind of touch sensor device. For example, in various cases, the implement may be a device attachable to a user's finger, a pointer device, and/or any other kind of implement utilizable with the touch sensor device. By way of another example, in various cases the touch sensor device may be any kind of electronic device (such as a desktop computer, a laptop computer, a wearable device, a smart phone, a digital media player, and/or any other electronic device) that includes a touch sensor (such as a track pad, an ultrasonic touch sensor, a capacitive touch sensor, a resistive touch sensor, a projection touch sensor, and/or any other kind of touch sensor).

The touch sensor device 102 may include a number of receiving elements that are operable to receive signals from one or more of a number of transmitting elements when one or more areas of the touch sensor device are contacted by the implement 101. Such received signals may be interpreted as touch input.

In some cases one or more portions (such as a tip and/or other portion) of the implement 101 may be specially configured to interact with the transmitting and/or receiving elements of the touch sensor device 102. For example, in cases there the touch sensor device is a capacitive touch sensor device, the tip of the implement may be formed of a material that will alter a capacitance in a portion of the touch sensor device associated with a transmitting and/or receiving element upon physical contact and/or close proximity with the portion.

FIG. 1B is a block diagram illustrating the functionality of a portion 104 of the touch sensor device 102 of FIG. 1A. As illustrated, the portion of the touch sensor device includes touch sensor elements 105 which may be receiving and/or transmitting elements.

FIG. 1C is a block diagram illustrating an embodiment of the functionality of an area 106 of the portion 104 of the touch sensor device 102 illustrated in FIG. 1B. In this embodiment, the touch sensor device may be a capacitive touch sensor device. As such, the area 106 may include metal elements 108 and 109. A transmitting element 107 may transmit a signal modulated according to a particular modulation. A receiving element 110 may determine whether or not a signal 111 is received that is modulated according to the modulation utilized by the transmitting element. Contact of the implement 101 between the metal elements 108 and 109 may alter the capacitance of the metal elements 108 and 109 such that the receiving element may receive the signal transmitted by the transmitting element. Absent such contact, the receiving element may not receive the signal.

Although FIG. 1C and the accompanying discussion above discusses an embodiment where the touch sensor device 102 is a capacitive touch sensor device, it is understood that this is an example. In other embodiments, the touch sensor device may be a, an ultrasonic touch sensor device, a resistive touch sensor device, a projection touch sensor device, and/or any other kind of touch sensor device.

Returning to FIG. 1A, the implement 101 may include a signal source (see FIG. 1D) which may provide a signal to the touch sensor device 102, the amplitude of which may be controllable by the selection element 104. The signal provided by the implement may be received by one or more receiving elements of the touch sensor device and may be interpreted as touch input and/or non-positional information regarding other received touch input.

In some implementations, the signal provided by the implement 101 may be modulated the same as signals transmitted by transmitting elements of the touch sensor device 102. In such implementations, the implement 101 may contact a portion of the touch sensor device, causing a receiving element associated with that portion to receive the signal transmitted by a transmitting element associated with that portion. During contact, the implement may also be provided to the touch sensor device, which may be received by the receiving element associated with the portion. The signal may radiate outward from the portion physically contacted such that nearby (adjacent) receiving elements associated with nearby (adjacent) portions of the touch sensor device also receive the signal provided by the implement. Because the signal provided by the implement is modulated the same as signals from transmitting elements, receiving elements may interpret the two signals the same. The number of nearby receiving elements that receive the signal provided by the implement may be dependent on the amplitude of the signal, which may be controlled by the selection element 104. In some cases, the greater the amplitude, the greater the number of receiving elements receive the signal provided by the implement.

The touch sensor device 102 may determine one or more areas of the touch sensor device that are touched by including the portion associated with the receiving element that received the signal from the transmitting element (i.e., the portion physically touched by the implement 101) with portions associated with the receiving elements that received the signal provided by the implement but not the signal from transmitting elements (i.e., portions nearby the portion physically touched by the implement). As such, the amount of the area of the touch sensor device that the touch sensor device may determine are touched is controllable via the selection element 104 and may be independent of the actual physical “footprint” of the implement (i.e., the amount of the implement that can physically touch the touch sensor device at one time).

For example, a graphics program associated with the touch sensor device 102 may enable a user to draw a line. The thickness of the line at a given point may be dependent on the amount of area of the touch sensor device determined to be touched by the implement 101. As such, despite the unchanging physical area of the implement, the user may control the thickness of the line by increasing and/or decreasing the amplitude of the signal provided by the implement utilizing the selection element 104.

In other implementations, the signal provided by the implement 101 may be modulated differently than signals transmitted by transmitting elements of the touch sensor device 102. In such implementations, the implement 101 may contact a portion of the touch sensor device, causing a receiving element associated with that portion to receive the signal transmitted by a transmitting element associated with that portion. The touch sensor device may interpret this as a touch occurring at the area of the touch sensor device corresponding to the portion physically touched by the implement. During contact, the implement may also be provided to the touch sensor device, which may be received by the receiving element associated with the portion. As the signal provided by the implement is modulated differently than the signal transmitted by the transmitting elements, the receiving element may be able to distinguish between the two signals. The received signal provided by the implement may be interpreted as representing non-positional information about the touch of the portion.

Such information may indicate any kind of information regarding the touch. For example, such information may include color information to be utilized with the detected touch, vibrancy information to be utilized with the detected touch, hue information to be used with the detected touch, brush stroke and/or other art implement information to be used with the detected touch, tone information to be used with the detected touch, line type information to be used with the detected touch, selection information to be used with the detected touch, and/or any other such touch related information.

The information indicated may depend on the amplitude of the signal provided by the implement 101. For example, a graphics program associated with the touch sensor device 102 may enable a user to draw a line. The color of the line at a given point associated with the portion of the touch sensor device physically touched by the implement may be dependent on the amplitude of the signal provided by the implement. For instance, the amplitude may be associated with a color spectrum such that white is associated with the lowest possible amplitude, black is associated with the highest possible amplitude, and colors between white and black on the spectrum are associated with corresponding intermediate amplitudes. As such, a user may be able to indicate the color that a line should be at a given point by controlling the selection element 104.

In still other implementations, the signal source of the implement 101 may produce multiple signals and the implement may be able to provide such multiple signals. In such implementations, one or more signals may be modulated the same as signals transmitted by transmitting elements of the touch sensor device 102 and one or more signals may be modulated differently. In this way, signals provided by the implement may be used to both simulate touch of the implement on more of the touch sensor device than the implement can physically touch at one time and to convey non-positional information regarding touches.

FIG. 1D is a block diagram illustrating the functionality of an example implementation of the implement 101 of FIG. 1A. As illustrated, the implement may include a signal source 112 that is coupled to an amplifier 114 and the selection element 104 via a variable resistor 113. The output of the amplifier may be provided to a transmitter element 115 which may radiate the signal 116 outward from the implement.

The selection element 104 may control the variable resistor 113, which may in turn control the amplifier 114. As such, the selection element may control the amplitude of the signal that is provided to the transmitter element 115 by the amplifier. In this way, the signal may be provided by the implement 101 with a range of possible amplitudes.

As shown, the selection element 104 may be a button that can be pressed by a user with varying degrees of force to cause the signal to be provided with a corresponding varying amplitude. However, it is understood that this is an example. In various implementations, the selection element may be any kind of selection element utilizable to provide varying input. For example, such a selection element may be a grip sensor that senses the amount of force with which a user grips the implement 101 to indicate a corresponding amplitude for the provided signal. By way of another example, such a selection element may be a pressure sensor that senses the amount of pressure exerted on the implement by the user to indicate a corresponding amplitude for the provided signal. By way of still another example, such a selection element may be strain gauge that detects a strain exerted by the user on the implement to indicate a corresponding amplitude for the provided signal.

In some cases, the implement 101 may be a stylus and the selection element 104 may be a pressure and/or similar sensor on the tip of the stylus that detects how hard or soft a user presses the tip of the stylus against a surface. In this way, the user may be able to control the amplitude of the signal by pressing harder or softer as opposed to having to separately control a selection mechanism coupled elsewhere to the stylus.

Additionally, in various cases the selection element may be one or more selection elements 104 that are not utilizable to provide varying degrees of input. Instead, such a selection element may comprise a plurality of buttons and/or other binary selection elements that can either be turned on or off to indicate a particular amplitude. For example, in a case where amplitude of the provided signal is utilized to determine an area touched, activation of a first button may indicate to provide the signal with a low amplitude to indicate that the touch of the implement should only be interpreted as touching where the implement actually touches. Further, activation of a second button may indicate to provide the signal with a medium amplitude to indicate that the touch of the implemented should be interpreted as touching a small area around where the implement actually touches. Additionally, activation of a third button may indicate to provide the signal with a high amplitude to indicate that the touch of the implemented should be interpreted as touching a large area around where the implement actually touches.

By way of another example, in a case where amplitude of the provided signal is utilized to determine a brush type associated with an area touched as opposed to determining a size of the area touched, activation of a first button may indicate to provide the signal with a low amplitude to indicate that a round brush should be used. Further, activation of a second button may indicate to provide the signal with a medium amplitude to indicate that a square brush should be used. Additionally, activation of a third button may indicate to provide the signal with a high amplitude to indicate that a triangular brush should be used.

Although the implement 101 is illustrated in FIG. 1D and described above as including particular components arranged in a particular configuration, it is understood that this is an example. In various implementations, various combinations of the same, similar, and/or different components may be utilized to enable the implement to provide one or more signals of various amplitudes without departing from the scope of the present disclosure. For example, in some cases the implement may not include a variable resistor 113 and the selection element 104 may control the amplifier 114 directly. By way of another example, in other cases the implement may not include an amplifier and the variable resistor may provide the signal to the transmitter element 115 under the control of the selection element.

As discussed above, in some implementations the signal provided by the implement 101 may be omnidirectional. However, in other implementations the direction of the signal may be controlled. For example, the implement may include one or more shielding elements that control emanation of the signal, and thusly to which portions of the touch sensor device 102 the signal is provided. By way of an example, such directional control may be utilized to control the portions of a graphical program displayed on the touch sensor device are affected by a ‘spray can’ type graphical painting tool associated with the implement 101. Such shielding elements may be dynamically controllable, such as by software and/or by mechanical control.

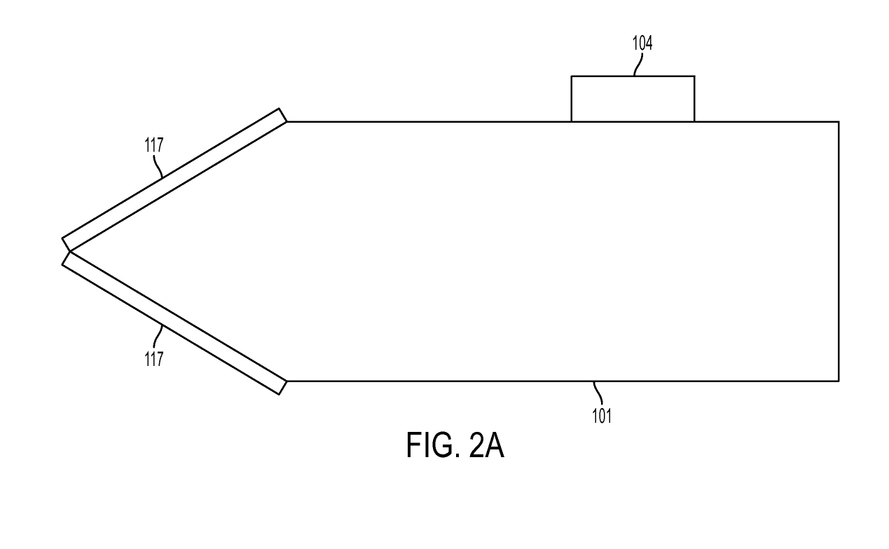

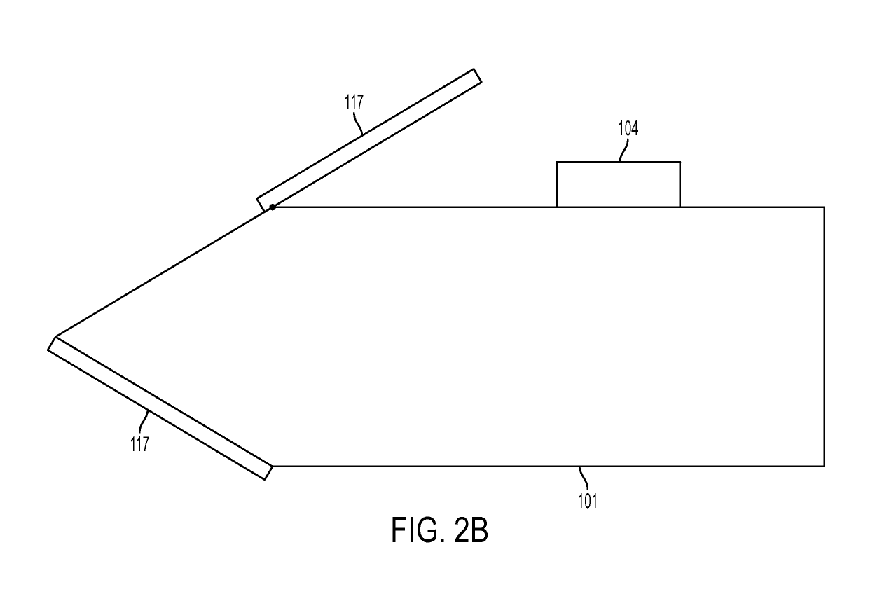

For example, FIG. 2A is a first side view of an alternative embodiment of the implement 101 of FIG. 1A that includes multiple shielding elements 117. In this embodiment, the various multiple shielding elements may be physically slideable to cover and/or reveal all portions of the implement from which the signal emanates. In FIG. 2A the shielding elements are shown slid closed such that no signal is provided by the implement. In FIG. 2B, one of the shielding elements is shown slid fully open such that the signal is able to emanate unhindered in the direction of the portion revealed by the slid open shielding element.

Although the embodiment of the implement shown in FIGS. 2A and 2B is shown and described above as including particular shielding elements 117 that operate in a particular fashion, it is understood that this is an example. In various implementations, various other mechanisms may be utilized to control emanation of the signal provided by the implement without departing from the scope of the present disclosure.

For example, in various implementations the implement 101 may include a single shielding element instead of multiple shielding elements. Alternatively, in other implementations, the implement may include more than two shielding elements. Adjustment of such shielding elements may be manually controlled, software controlled, mechanically controlled, and/or otherwise controlled.

Further, in some implementations the shielding of the implement 101 may be fixed and the position of the component of the implement used to transmit the signal (such as the transmitter element 115 of FIG. 1D) may be altered. Such position alteration of the component used to transmit the signal may adjust the position with respect to the fixed shielding element such that the amount of emanation of the signal and/or the direction of the signal is adjusted.

Additionally, in various implementations elements other than shielding may be utilized to adjust the emanation of the signal and/or the direction of the signal. For example, a component of the implement 101 utilized to transmit the signal may comprise an array of elements that may be individually activated to transmit the signal, activated at various partial strengths to transmit the signal in a stronger and/or weaker manner, and/or deactivated to not transmit the signal. By activating, activating at partial strengths, and/or deactivating various of elements of the array, the amount of emanation of the signal and/or the direction of the signal may be adjusted.

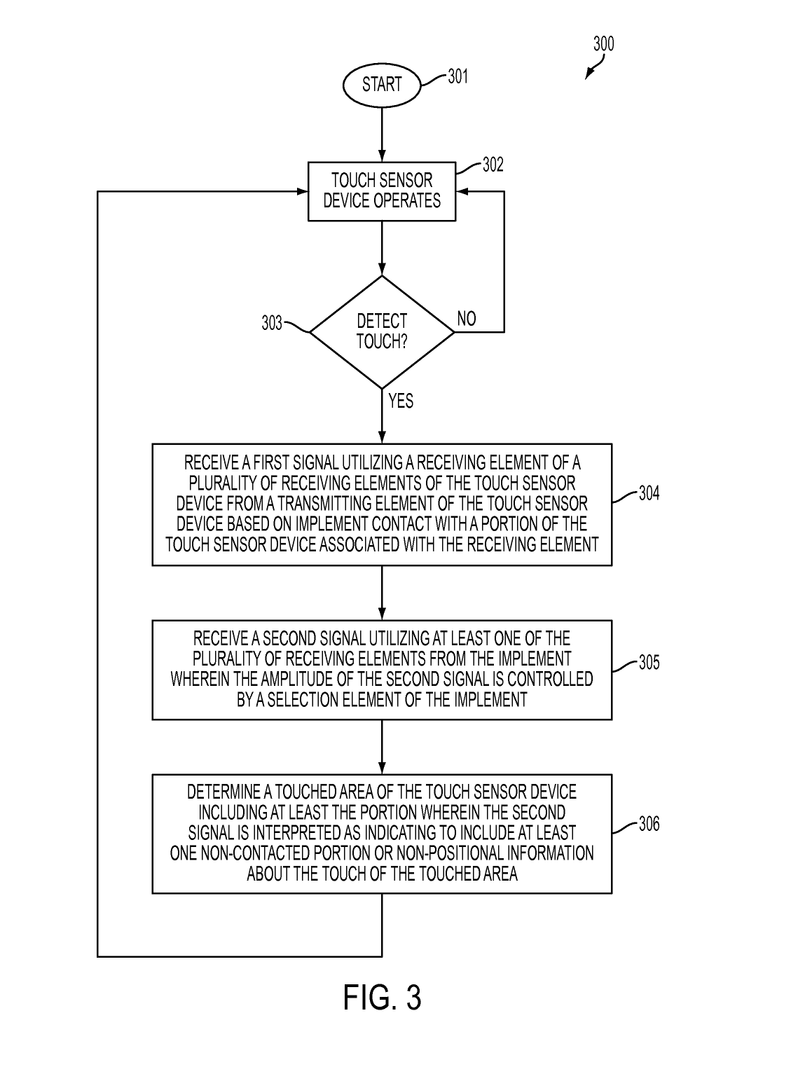

FIG. 3 is a flow chart illustrating a method 300 for expanded touch sensor device implement functionality. This method may be performed by the system of FIG. 1A.

The flow begins at block 301 and may proceed to block 302 where a touch sensor may device operate. The flow may then proceed to block 303 where the touch sensor device may determine whether or not to detect the touch of an implement. If so, the flow may proceed to block 304. Otherwise, the flow may return to block 302 where the touch sensor device may continue to operate.

At block 304, after the touch sensor device determines to detect the touch of an implement, a first signal may be received utilizing a receiving element of a plurality of receiving elements of the touch sensor device from a transmitting element of the touch sensor device. Such signal receipt may be based on implement contact with a portion of the touch sensor device associated with the receiving element. The flow may then proceed to block 305 where a second signal may be received utilizing at least one of the plurality of receiving elements from the implement. The amplitude of the second signal may be controlled by a selection element of the implement. Next, the flow may proceed to block 306 where a touched area of the touch sensor device may be determined by including at least the portion. The second signal may be interpreted as indicating to include at least one-non-contacted portion. Alternatively and/or additionally, the second signal may be interpreted as indicating non-positional information about the touch of the touched area

The flow may then return to block 302 where the touch sensor device continues to operate.

Although the method 300 is illustrated and described as including particular operations performed in a particular order, it is understood that this is an example. In various implementations, various configurations of the same, similar, and/or different operations may be performed without departing from the scope of the present disclosure. For example, the operations of receiving the first and second signals are shown as sequential operations performed in a linear fashion. However, in various implementations the operations of receiving the first and second signals may be performed independently in a simultaneous, substantially simultaneous, parallel, reversed, and/or otherwise fashion.

Returning to FIG. 1, although the implement 101 is shown and described as actually contacting the touch sensor device 102, it is understood that this is an example. In various implementations, other configurations are possible without departing from the scope of the present disclosure. For example, in some implementations, the touch sensor device may project an image on a surface and utilize one or more cameras to detect a portion of the image touched by the implement. As such, the implement may not physically touch the touch sensor device at all.

In such a case, the implement may include a transmitter (such as a WiFi transmitter, a Bluetooth transmitter, an infrared transmitter, a near field communication transmitter, a cellular communication transmitter, a satellite communication transmitter, and/or other such wired and/or wireless transmitter) that provides a signal to the touch sensor device where the amplitude of such a signal either affects the area of the image determined to be touched by the implement by the camera(s) and/or indicates information regarding the touch of the area of the image detected by the camera(s).

As discussed above and illustrated in the accompanying figures, the present disclosure discloses systems and methods for expanded functionality of an implement utilized with a touch sensor device. A touch sensor device (such as a touch screen track pad, or other such touch sensor device) may include a number of receiving elements that are operable to receive signals from one or more of a number of transmitter elements when one or more areas of the touch sensor device are contacted with an implement (such as a stylus). Such received signals may be interpreted by the touch sensor device as touch input. The implement may include a signal source and one or more selection elements that control the amplitude with which a signal from the signal source is provided to the touch sensor device. Such signals from the implement may be received by one or more of the receiving elements of the touch sensor device and interpreted as touch input and/or non-positional information regarding other received touch input. In this way, the functionality of the implement when utilized with the touch sensor device may be enhanced.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

We claim:

1. A system for expanded touch sensor implement functionality, comprising:
a touch sensor device, comprising a plurality of receiving elements; and
an implement, comprising:
at least one signal source that provides at least one signal; and
at least one selection element that controls an amplitude at which the at least one signal is provided to the touch sensor device;
wherein at least one of the plurality of receiving elements receives the at least one signal.

2. The system of claim 1, wherein the touch sensor device includes a plurality of transmitting elements that transmit respective additional signals receivable by respective receiving elements of the plurality of receiving elements when the implement touches a respective portion of the touch sensor device wherein the touch sensor device determines that touches are detected based on signals received by the plurality of receiving elements.

3. The system of claim 2, wherein the touch sensor device determines a touch is detected in an area associated with one of the plurality of transmitting elements and one of the plurality of receiving elements when the one of the plurality of receiving elements receives one of the respective additional signals from the one of the plurality of transmitting elements facilitated by contact of the implement at the area.

4. The system of claim 3, wherein the touch sensor determines the touch is also detected in an additional area associated with an additional one of the plurality of receiving elements and not contracted by the implement when the additional one of the plurality of receiving elements receives the at least one signal.

5. The system of claim 4, wherein the one of the respective additional signals is modulated with a same modulation as the at least one signal.

6. The system of claim 5, wherein the implement further comprises at least one additional signal source that provides at least one additional implement signal to the touch sensor device wherein the touch sensor device interprets an amplitude of the at least one additional implement signal as information corresponding to at least one detected touch other than positional information.

7. The system of claim 4, wherein the additional area is adjacent to the area.

8. The system of claim 4, wherein the additional one of the plurality of receiving elements is adjacent to the one of the plurality of receiving elements.

9. The system of claim 4, wherein the additional one of the plurality of receiving elements comprises a number of receiving elements that is dependent on the amplitude of the at least one signal.

10. The system of claim 1, wherein the implement comprises a stylus.

11. The system of claim 1, wherein the touch sensor device comprises a capacitive touch sensor device.

12. The system of claim 1, wherein the touch sensor device interprets the amplitude of the at least one signal as information corresponding to at least one detected touch other than positional information.

13. The system of claim 12, wherein the information corresponding to the at least one detected touch comprises color information, vibrancy information, hue information, brush stroke or other art implement information, tone information, line type information, or selection information.

14. The system of claim 12, wherein the touch sensor device includes a plurality of transmitting elements that transmit respective additional signals receivable by respective receiving elements of the plurality of receiving elements when the implement touches a respective portion of the touch sensor device wherein the touch sensor device determines that touches are detected based on the respective additional signals received by the plurality of receiving elements and the respective additional signals and the at least one signal are differently modulated.

15. The system of claim 1, wherein the implement further comprises at least one shielding element that controls which of the plurality of receiving elements receives the at least one signal when the at least one signal is provided to the touch sensor device.

16. The system of claim 15, wherein the at least one shielding element is adjustable to vary which of the plurality of receiving elements receives the at least one signal when the at least one signal is provided to the touch sensor device.

17. The system of claim 1, wherein the at least one selection element comprises at least one button, strain gauge, pressure sensor, or grip sensor.

18. The system of claim 1, wherein the at least one selection element comprises at least one of a variable resistor or an amplifier.

19. An implement utilizable with a touch sensor device, comprising:
at least one signal source that provides at least one signal; and
at least one selection element that controls an amplitude at which the at least one signal is provided to a touch sensor device that includes a plurality of receiving elements;
wherein at least one of the plurality of receiving elements receives the at least one signal.

20. A method for expanded touch sensor device implement functionality, the method comprising:
receiving at least one first signal utilizing a receiving element of a plurality of receiving elements of a touch sensor device from a transmitting element of the touch sensor device based on a contact of an implement with a portion of the touch sensor associated with the receiving element;
receiving at least one second signal utilizing at least one of the plurality of receiving elements from the implement wherein an amplitude of the at least one second signal is controlled by at least one selection element of the implement; and
determining a touched area of the touch sensor including at least the portion wherein the at least one second signal is interpreted as at least one of:
indicating an additional portion of the touch sensor that is not contacted by the implement to include in the touched area in addition to the portion; or
indicating information other than positional information about a touch of the touch area.
